(19) United States
(12) Patent Application Publication
(10) Pub. No.: US 2026/0109549 A1
(43) Pub. Date: Apr. 23, 2026

(54) MECHANICAL DEVICE AND METHOD FOR TRANSPORTING AN OBJECT MOUNTED ON ROLLERS

(71) Applicant: TRUMPF Werkzeugmaschinen SE + Co. KG, Ditzingen (DE)

(72) Inventor: Norbert Kamper, Bautzen (DE)

(21) Appl. No.: 19/359,747

(22) Filed: Oct. 16, 2025

(30) Foreign Application Priority Data
Oct. 21, 2024 (DE) 102024210135.4

(51) Int. Cl. B65G 47/34

(52) U.S. Cl. CPC B65G 47/34; B65G 2201/0267; B65G 2207/32

(57) ABSTRACT

A mechanical device includes an object mounted on rollers, a first rail support and a second rail support separated from each other by an intermediate space, a first transport device for transporting the object along the first rail support between a first position, in which the object rests on the first rail support, and a transfer position, and a second transport device for transporting the object along the second rail support between a second position, in which the object rests on the second rail support, and the transfer position. In the transfer position, the object rests on both the first rail support and the second rail support.

### CROSS REFERENCE TO RELATED APPLICATIONS

This application claims benefit to German Patent Application No. DE 10 2024 210 135.4, filed on Oct. 21, 2024, which is hereby incorporated by reference herein.

### FIELD

Embodiments of the present invention relate to a mechanical device. Embodiments of the present invention also relate to a method for transporting an object mounted on rollers, preferably a pallet mounted on rollers.

### BACKGROUND

An object mounted on rollers, in particular a pallet, can be moved in an automated manner on a rail support, which typically comprises two parallel guide rails. It may be necessary for the pallet to be transported across an intermediate space between a first rail support and a second rail support. This is the case, for example, if one of the two rail supports is to be temporarily completely isolated from the surroundings by a housing. In this case, the two rail supports are spatially separated from each other and not mechanically coupled.

DE3240962A1 describes a device for the successive automatic transfer of pallets towards and away from a table of a machine tool. The device includes a bed anchored to the floor and has a bed carriage slidably attached to the bed to guide a pallet which is attached to the bed carriage. The device comprises a first transport mechanism for the linear movement of the bed carriage, as well as a driver which is fastened to the bed carriage and can engage with the pallet. The device also comprises a second transport mechanism for moving the driver back and forth in the direction of movement of the bed carriage. The first transport mechanism may consist of a piston-cylinder arrangement and the second transport mechanism may include gears around which an endless chain is tensioned.

US20180070595A1 describes a material processing system having conveyor belts for conveying a plurality of rows of containers along a conveyor path. The system may comprise a device for changing a direction of movement of the material, wherein the device generates a linear movement. The device may be a cylinder having a moving part to which a rod is attached which, during operation, contacts the material to be conveyed in order to push it onto a conveyor belt. The conveyor belt may have two driven chains between which rods are attached which are moved by means of the chains. The rods grip the containers to convey them.

JPS5193589U describes a pallet conveyor, in which a pallet is placed on a group of rollers that are slightly inclined relative to the horizontal. The pallet is moved by means of a slider to a higher inclined side of the group of rollers.

### SUMMARY

Embodiments of the present invention provide a mechanical device. The mechanical device includes an object mounted on rollers, a first rail support and a second rail support separated from each other by an intermediate space, a first transport device for transporting the object along the first rail support between a first position, in which the object rests on the first rail support, and a transfer position, and a second transport device for transporting the object along the second rail support between a second position, in which the object rests on the second rail support, and the transfer position. In the transfer position, the object rests on both the first rail support and the second rail support.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of a mechanical device with a pallet mounted on rollers, which is designed to transport the pallet between a first rail support and a second rail support, according to some embodiments;

FIG. 2 shows a schematic representation of the mechanical device of FIG. 1 with the pallet in a first position, in which it rests on the first rail support, according to some embodiments;

FIG. 3 and FIG. 4 show schematic representations of the mechanical device of FIG. 1 with the pallet in a transfer position according to some embodiments;

FIG. 5 shows a schematic representation of a first transport device with a cylinder-piston drive for transporting the pallet along the first rail support according to some embodiments; and

FIG. 6 shows a schematic representation of the mechanical device of FIG. 1 with the pallet in a second position, in which it rests on the second rail support, according to some embodiments.

### DETAILED DESCRIPTION

Embodiments of the present invention provide a mechanical device and a method which enable an automated, process-reliable transportation of an object mounted on rollers, in particular a pallet, over an intermediate space between two rail supports.

According to embodiments of the invention, a mechanical device, comprises: an object mounted on rollers, preferably a pallet mounted on rollers, a first rail support and a second rail support separated from each other by an intermediate space, a first transport device for transporting the object along the first rail support between a first position, in which the object rests on the first rail support, and a transfer position, as well as a second transport device for transporting the object along the second rail support between a second position, in which the object rests on the second rail support, and the transfer position, wherein, in the transfer position, the object rests on both the first rail support and the second rail support.

In the device described herein, a process-reliable, automated transfer of the object between the first transport device and the second transport device is made possible in that, in the transfer position, the object rests on both rail supports. To achieve this, the object in the transfer position typically rests with at least one roller on the first rail support and with at least one further roller on the second rail support. In this way, the object can be transported in a process-reliable manner “freely suspended” over an intermediate space that has a comparatively large width of, for example, more than 0.5 m.

In one embodiment, the mechanical device comprises a separating device, preferably a lifting door, and a moving device for moving the separating device between a locked position, in which the separating device blocks the intermediate space in the region of the rail supports, and a release position, in which the separating device releases the intermediate space in the region of the rail supports for transporting the object.

As described above, in certain cases it is advantageous to insert a separating device in the intermediate space between the two rail supports, which prevents the object from being transported between the two rail supports. The separating device can, for example, be a lifting door that can be moved between the locked position and the release position by a lifting and lowering movement. However, the moving device can also be designed to laterally displace and/or pivot the separating device for movement between the locked position and the release position. The separating device can be substantially flat, but it can also deviate from a planar geometry.

In a further development of this embodiment, the mechanical device comprises a housing in which the first rail support is arranged, wherein the housing can be closed by moving the separating device into the locked position. In particular, the separating device can hermetically seal the housing from the surroundings in the locked position. This is advantageous, for example, when noise is generated within the housing during handling or processing of the object or items placed on the object, such as workpieces or workpiece parts. By hermetically sealing the interior of the housing from the environment, noise development outside the housing can be kept to a minimum. It is understood that, in this case, for noise protection reasons, neither the housing nor the separating device may have an opening when the separating device is in the closed position. It is further understood that the housing of the first rail support can also be hermetically sealed from the environment for reasons other than noise protection. More than one separating device can also be provided to hermetically seal the housing from the environment.

In a further embodiment, the first transport device has a first driver and is designed to move the first driver, preferably at the transfer position, between an engagement position for engaging in a first guide slot of the object and a release position, in which the first driver does not engage in the first guide slot of the object, and/or the second transport device has a second driver and is designed to move the second driver, preferably at the transfer position, between an engagement position for engaging with a second guide slot of the object and a release position, in which the second driver does not engage with the second guide slot of the object.

For the movement of the object between the first/second position and the transfer position, the first/second transport device typically has a first/second drive that moves the first/second driver along the rail support, typically displacing it when it is in engagement with the first/second guide slot of the object. For the transfer at the transfer position, the engagement of the first driver on the first guide slot can be released and the second driver can be brought into engagement with the second guide slot, and vice versa. For process reliability, it is beneficial if at least one of the two drivers is in engagement in the respective guide slot at all times. This can be ensured by first moving both drivers into the respective engagement position in the transfer position, before one of the two drivers is moved into the release position.

In one embodiment, the first transport device for moving the object along the first rail support has a cylinder-piston drive or a spindle drive. A drive of this type has proven to be advantageous when only limited installation space is available for the drive. The cylinder-piston drive can, for example, comprise a pneumatic cylinder or an electric cylinder to move a piston rod linearly. The first driver can be attached to the piston rod of the cylinder-piston drive or to a threaded spindle of the spindle drive. The stroke of the linear movement of the first driver typically corresponds to the distance between the first position and the transfer position of the object.

In a further development of this embodiment, the first driver is attached to a piston rod of the cylinder-piston drive, wherein, for moving the first driver between the engagement position and the release position, a cylinder of the cylinder-piston drive is movable, in particular pivotable and/or can be raised and lowered in a linear movement. To generate a linear movement of the object along the rail support, a linear movement of the piston rod is sufficient, which typically occurs in the horizontal direction. However, the linear movement of the piston rod generally does not allow movement of the first driver between the engagement position and the release position. To make this possible, it is advantageous if the cylinder of the cylinder-piston drive can be moved. The movement of the cylinder can be a pivoting movement, which changes the angular position of the cylinder. In this case, the cylinder can, for example, be attached to a pivot bearing at its end facing away from the piston rod. In this case, the piston rod or the first driver can be moved back and forth between the engagement position and the release position in the transfer position by means of a suitable drive, for example by means of a short-stroke cylinder. The driver or piston rod of the cylinder can be moved along a guideway. It is also possible to raise or lower the cylinder and piston rod of the cylinder-piston drive in a linear movement to realize the movement between the engagement position and the release position. The first driver can, for example, be designed in the form of a driver pin or the like, which engages in a suitably shaped guide slot on the underside of the object, typically on the underside of the pallet.

In a further embodiment, the first transport device is designed to place the object with at least one roller, in particular with exactly one roller, down on the second rail support when moving into the transfer position. In particular, if the first transport device has a cylinder-piston drive or a spindle drive, the stroke of the linear movement between the transfer position and the first end position should not be too large. It is therefore advantageous if the object is moved with the first transport device only so far along the first rail support that, in the transfer position, only one of the rollers rests on the second rail support.

In a further embodiment, the first driver, in particular in the form of a driver pin, does not protrude above the rail support in the release position. In this case, when moving into the release position, the first driver is lowered beneath the rail support or beneath the contact surface of the guide rail and can be run over by the roller-mounted object when the second transport device moves the object from the transfer position to the second position.

In a further embodiment, the second transport device for moving the object along the second rail support has a chain drive. A chain drive is a proven drive for moving objects mounted on rollers, in particular a pallet or pallet truck. The chain drive has a second driver, e.g. in the form of a hook, which is typically attached to the chain of the chain drive and engages with the second guide slot on the object in order to move it from the transfer position to the second position. The second guide slot can, for example, be attached near the roller of the object that rests on the second rail support in the transfer position.

The second rail support can, for example, be part of a removal station for removing workpiece parts that are stored on top of the pallet. The first rail support can, for example, be part of a handling station for handling a workpiece stored on the top of the pallet or workpiece parts stored there. The handling station can, for example, be a separation station where workpiece parts are separated from a remaining workpiece.

A further aspect of the invention relates to a method for transporting an object mounted on rollers, preferably a pallet mounted on rollers, between a first rail support and a second rail support, which are separated from each other by an intermediate space, comprising the steps: Transporting of the object by means of a first transport device along the first rail support between a first position, in which the object rests on the first rail support, and a transfer position, and transporting of the object between the transfer position and a second position, in which the object rests on the second rail support, by means of a second transport device, wherein, in the transfer position, the object rests on both the first rail support and the second rail support.

In the first position, the object rests only on the first rail support, in the second position the object rests only on the second rail support. As described above, process-reliable transport of the object can be ensured by partially supporting the object, or more precisely the object's rollers, on the first rail support and on the second rail support in the transfer position.

In a variant of the method, before moving the object into the transfer position, a separating device, preferably a lifting door, is moved from a locked position, in which the separating device blocks the intermediate space in the region of the rail supports, into a release position, in which the separating device releases the intermediate space in the region of the rail supports for transporting the object. As described above, the separating device or the lifting doors can be moved into the locked position in order to separate a housing in which the first rail support is arranged from the environment, for example in order to achieve a noise protection effect.

In a further variant, for transferring the object from the first rail support to the second rail support, a first driver of the first transport device is released at the transfer position from an engagement position in which the first driver engages in a first guide slot of the object, and a second driver of the second transport device is moved into an engagement position in which the second driver is engaged with a second guide slot of the object, and/or, for transferring the object from the second rail support to the first rail support, a second driver of the second transport device is released at the transfer position from an engagement position in which the second driver engages in a second guide slot of the object, and a first driver of the first transport device is moved into an engagement position in which the first driver is engaged with a first guide slot of the object. As described above, it is advantageous if the release of a respective driver from the engagement position only occurs when the other driver has also reached the engagement position. In this way, process reliability during transfer of the object can be increased.

In a further variant, the first transport device has a cylinder-piston drive, on the piston rod of which the first driver is attached, wherein, for moving the first driver between the engagement position and a release position, in which the first driver is not in engagement with the first guide slot, a cylinder of the cylinder-piston drive is moved, in particular pivoted and/or raised or lowered in a linear movement. When pivoting, the piston rod is typically tilted at a comparatively small angle so that the first driver can be lowered or raised in a linear movement. Such a movement of the first driver can also be achieved by raising or lowering the cylinder in a linear movement.

In a further variant, the first transport device, during the movement of the object into the transfer position, sets down the object on the second rail support using at least one roller, in particular using exactly one roller. As described above, it is typically advantageous if the stroke or distance between the first end position and the transfer position is not too large when transporting the object. A small stroke can be achieved by placing only one outer roller of the object on the second rail support during transport to the transfer position, while the other rollers of the object remain on the first rail support. Typically, the object comprises more than two rollers, which are arranged laterally offset along the rail supports in the direction of movement of the object. In the case of two parallel guide rails, “a roller” is understood to mean a pair of rollers which are arranged at the same height in the direction of movement of the object and which can be connected to each other by a common axis.

In a further variant, the first driver, in particular in the form of a driver pin, does not protrude over the first rail support in a release position in which the driver is not engaged with the first guide slot. In this way, the driver can be overrun by the object or the rollers of the object when it is moved from the transfer position to the second position.

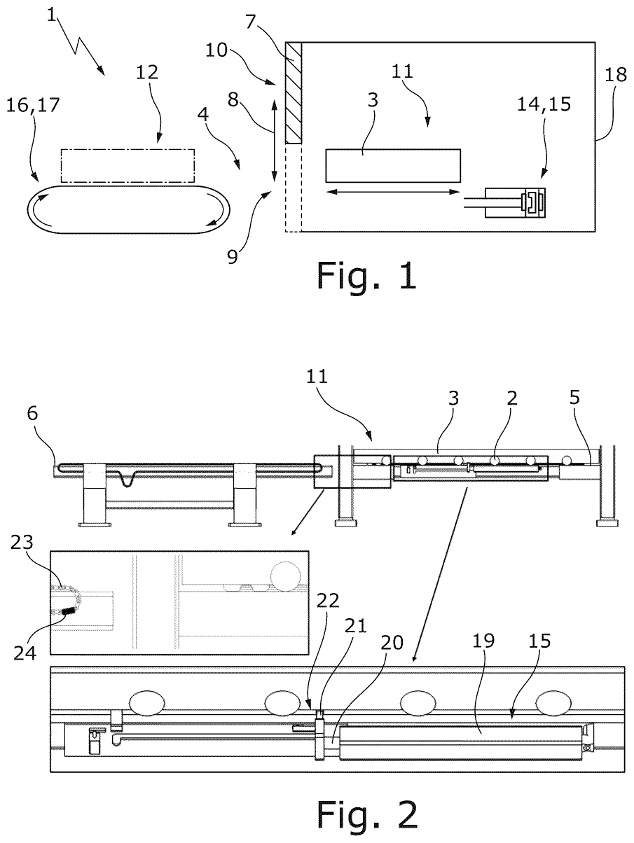

FIGS. 1 to 4 and 6 show a mechanical device 1 which serves to transport an object mounted on rollers 2, in the form of a pallet 3, across an intermediate space 4. The intermediate space 4 separates a first rail support 5 on a first side of the intermediate space 4 from a second rail support 6 on a second side of the intermediate space 4. In the example shown, the first rail support 5 is part of a separation station for separating workpiece parts from a residual skeleton. In the example shown, the second rail support 6 is part of a removal station for removing workpiece parts, which are transported from the separation station to the removal station with the aid of the pallet 3. The two rail supports 5, 6 are each attached to a supporting frame.

The mechanical device 1 comprises a separating device, in the example shown a lifting door 7, and a moving device 8 indicated by a double arrow for moving the lifting door 7 in the vertical direction between a locked position 9 indicated by dashed lines in FIG. 1, in which the lifting door 7 blocks the intermediate space 4 in the area of the rail supports 5, 6, and a release position 10, also shown in FIG. 1, in which the lifting door 7 releases the intermediate space 4 in the area of the rail supports 5, 6 for transporting the pallet 3.

In FIG. 1 and FIG. 2, the pallet 3 is shown in a first position 11, in which the pallet 3 rests completely, i.e., with all rollers 2, on the first rail support 5. The transport of the pallet 3 from the first position into a second position 12, indicated by dashed lines in FIG. 1, in which the pallet 3 rests with all rollers 2 on the second rail support 6, takes place via a transfer position 13, in which the pallet 3 rests with one roller 2 on the second rail support 6 and with all other rollers 2 on the first rail support 5. The process sequence for transporting the pallet 3 from the first position 11 to the second position 12 is described below in connection with FIGS. 2 to 6.

A first transport device 14, which in the example shown has a cylinder-piston drive 15, is used to transport the pallet 3 along the first rail support 5 from the first position 11 to the transfer position 13. A second transport device 16, which in the example shown has a chain drive 17, is used to transport the pallet 3 along the second rail support 6 from the transfer position 13 to the second position 12.

The first rail support 5 is arranged in a housing 18, which is shown in FIG. 1. The housing 18 can be closed by moving the lifting door 7 into the locked position 9. In the example shown, the housing 18 is designed to completely separate the interior of the housing 18 from the surroundings of the housing 18 when the lifting door 7 is closed. In this way, when machining workpiece parts that are placed or to be placed on the pallet 3 during separation within the interior of the housing 18, the noise development outside the housing 18 can be kept low. Due to the housing 18, the available installation space for the first transport device 14 is limited.

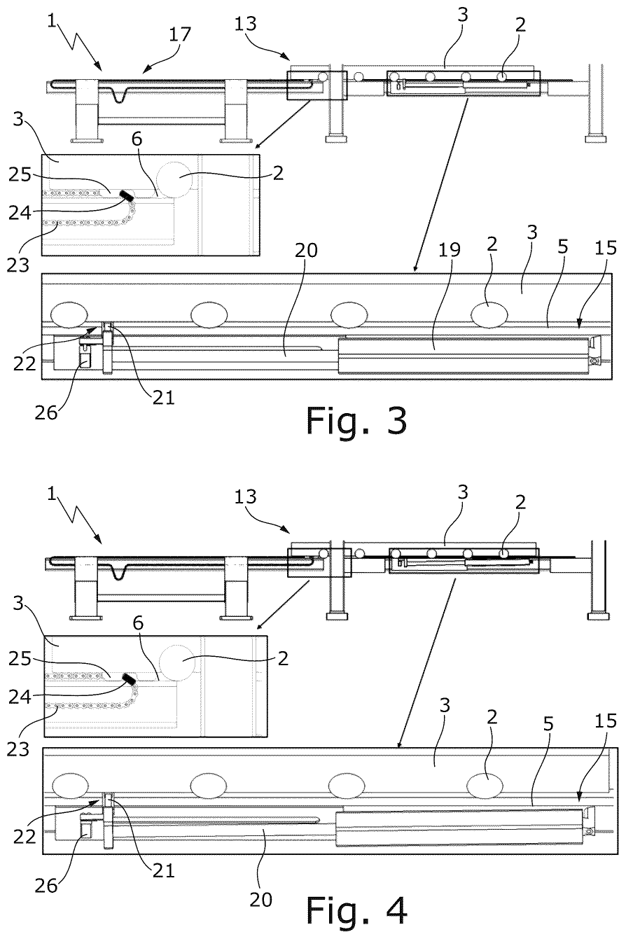

The cylinder-piston drive 15 of the first transport device 14 has a pneumatic cylinder 19 with a piston rod 20, at the free end of which a first driver 21 is attached, which is designed as a driver pin. The driver pin 21 is in the first position 11 of the pallet 3 shown in FIG. 2 in an engagement position in which the driver pin 21 engages in a first guide slot 22 in the pallet 3, which is located on the underside of the pallet 3. The pallet 3 is moved by the cylinder-piston drive 15 from the first position 11 into the transfer position 13 by extending the piston rod 20 and thereby linearly displacing the pallet 3, in whose first guide slot 22 the first driver in the form of the driver pin 21 engages, along the first rail support 5. As can be seen in FIG. 3, the first transport device 14 is designed to place the pallet 3 with exactly one roller 2 on the second rail support 6 during the movement into the transfer position 13.

As can be seen in FIG. 2, the chain drive 17 of the second transport device 16 has an endless chain 23 to which a second driver 24 is attached, which is located in a release position below the second rail support 6 when the pallet 3 rests on the first rail support 5. When the pallet 3 reaches the transfer position 13, which can be detected by a suitable sensor, the second driver 24 is moved from the release position to an engagement position in which it engages in a second guide slot 25 on the underside of the pallet 3, as shown in FIG. 3. The first driver in the form of the driver pin 21 initially remains in the engagement position in the first guide slot 22 of the pallet 3 in order to secure it. Only when the second driver 24, which is attached to the endless chain 23, is in the engagement position in the second guide slot 25, the driver pin 21 is moved from the engagement position to a release position (see FIG. 4).

The driver pin 21 is moved from the engagement position shown in FIG. 3 into the release position shown in FIG. 4 by means of a drive in the form of a short-stroke cylinder 26, which, in the fully extended position of the piston rod 20, moves the driver pin 21 downwards in the vertical direction. In this case, the cylinder 19 of the cylinder-piston drive 15, which is connected to a pivot bearing 27 on its side facing away from the piston rod 20, is pivoted. The piston rod 20 with the driver pin 21 is guided along a guideway 28 during pivoting.

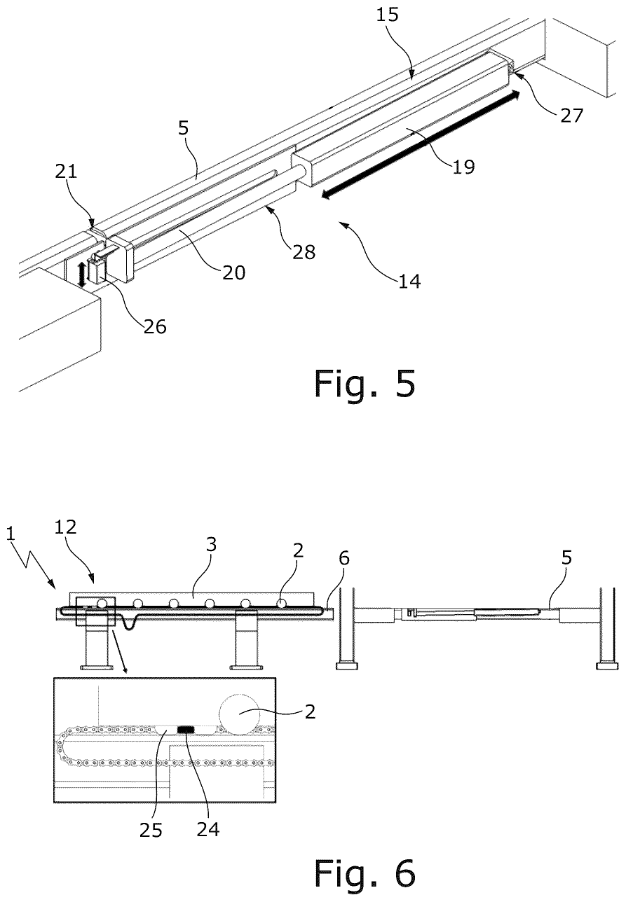

As can be seen in FIG. 5, the driver pin 21 does not protrude above the first rail support 5 in the release position. If the driver pin 21 is in the release position, the pallet 3 can be moved by means of the chain drive 17 from the transfer position 13 shown in FIG. 4 into the second position 12 shown in FIG. 6, in which the pallet 3 rests completely on the second rail support 6. Here, the pallet 3 is moved along the second rail support 6 by means of the second driver 24, which engages in the second guide slot 25. To move the pallet 3 from the second position 12 to the first position 11, the steps described above can be carried out in reverse.

As an alternative to the pivoting movement of the cylinder 19 shown in FIG. 5, it can also be lowered in a linear movement in order to move the driver pin 21 back and forth between the release position and the engagement position. Instead of the cylinder-piston drive 15, another type of drive can be used which requires a comparatively small installation space, for example a spindle drive or the like. Instead of a pallet 3, other objects mounted on rollers 2 can also be moved between the first position 11 and the second position 12 in the manner described above.

1. A mechanical device, comprising:
an object mounted on rollers,
a first rail support and a second rail support separated from each other by an intermediate space,
a first transport device for transporting the object along the first rail support between a first position, in which the object rests on the first rail support, and a transfer position, and
a second transport device for transporting the object along the second rail support between a second position, in which the object rests on the second rail support, and the transfer position,
wherein in the transfer position, the object rests on both the first rail support and the second rail support.

2. The mechanical device according to claim 1, further comprising:
a separating device, and
a moving device for moving the separating device between a locked position, in which the separating device blocks the intermediate space, and a release position, in which the separating device releases the intermediate space for transporting the object.

3. The mechanical device according to claim 2, further comprising:
a housing in which the first rail support is arranged, wherein the housing is capable of being closed by moving the separating device into the locked position.

4. The mechanical device according to claim 1, wherein the first transport device comprises a first driver and is configured to move the first driver between an engagement position for engaging in a first guide slot of the object and a release position, in which the first driver does not engage in the first guide slot of the object
and/or
wherein the second transport device comprises a second driver and is configured to move the second driver between an engagement position for engaging with a second guide slot of the object and a release position, in which the second driver does not engage with the second guide slot of the object.

5. The mechanical device according to claim 4, wherein the first transport device for moving the object along the first rail support comprises a cylinder-piston drive or a spindle drive.

6. The mechanical device according to claim 5, wherein the first driver is attached to a piston rod of the cylinder-piston drive, wherein, for moving the first driver between the engagement position and the release position, a cylinder of the cylinder-piston drive is movable.

7. The mechanical device according to claim 1, wherein the first transport device is configured to place the object with at least one roller, down on the second rail support when moving into the transfer position.

8. The mechanical device according to claim 4, wherein the first driver does not protrude above the first rail support in the release position.

9. The mechanical device according to claim 1, wherein the second transport device comprises a chain drive for generating a linear movement of the object along the second rail support.

10. A method for transporting an object mounted on rollers between a first rail support and a second rail support, which are separated from each other by an intermediate space, the method comprising:
transporting the object by using a first transport device along the first rail support between a first position, in which the object rests on the first rail support, and a transfer position, and
transporting the object between a second position, in which the object rests on the second rail support, and the transfer position by using a second transport device,
wherein in the transfer position, the object rests on both the first rail support and the second rail support.

11. The method according to claim 10, wherein, before moving the object into the transfer position, a separating device is moved from a locked position, in which the separating device blocks the intermediate space, into a release position, in which the separating device releases the intermediate space for transporting the object.

12. The method according to claim 10, wherein, for transferring the object from the first rail support to the second rail support, a first driver of the first transport device is released at the transfer position from an engagement position in which the first driver engages in a first guide slot of the object, and a second driver of the second transport device is moved into an engagement position in which the second driver is engaged with a second guide slot of the object, and/or
wherein, for transferring the object from the second rail support to the first rail support, the second driver of the second transport device is released at the transfer position from the engagement position in which the second driver engages in the second guide slot of the object, and the first driver of the first transport device is moved into the engagement position in which the first driver is engaged with the first guide slot of the object.

13. The method according to claim 12, wherein the first transport device comprises a cylinder-piston drive, on the piston rod to which the first driver is attached, wherein, for moving the first driver between the engagement position and a release position, in which the first driver is not in engagement with the first guide slot, a cylinder of the cylinder-piston drive is moved.

14. The method according to claim 10, wherein the first transport device, during movement of the object into the transfer position, sets down the object on the second rail support using at least one roller.

15. The method according to claim 12, wherein the first driver does not protrude above the first rail support in a release position in which the first driver is not engaged with the first guide slot.
